(19) United States
(12) Patent Application Publication
(10) Pub. No.: US 2014/0074643 A1
(43) Pub. Date: Mar. 13, 2014

(54) PROCESSING REQUESTS FOR PROPOSALS

(71) Applicant: Michael Lewis Belson, Oak Park, CA (US)

(72) Inventor: Michael Lewis Belson, Oak Park, CA (US)

(21) Appl. No.: 14/026,875

(22) Filed: Sep. 13, 2013

Related U.S. Application Data
(60) Provisional application No. 61/700,775, filed on Sep. 13, 2012.

(51) Int. Cl. G06Q 30/06

(52) U.S. Cl. CPC G06Q 30/0611
USPC 705/26.3

(57) ABSTRACT

There is disclosed a method and apparatus for processing requests for proposals. The method includes receiving a request for proposal including a project to be completed and an estimated budget for the project, accepting funds into an escrow account to partially-fund the project, and receiving interactions with the request for proposal from a first and a second potential seller, the interactions including a selected one of (1) discussion regarding the project, and (2) a bid on the project. The method further includes accepting additional funds into the escrow account in order to more fully fund the project, determining that one of (1) a project award indicating that the project has been awarded to the seller has been received or (2) a project term has lapsed, and providing all funds in the escrow account to a group including at least one of the first and the second potential seller.

### RELATED APPLICATION INFORMATION

This patent claims priority from U.S. provisional patent application No. 61/700,775 filed on Sep. 13, 2012 and entitled “Processing Requests for Proposals.”

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to processing requests for proposals.

2. Description of the Related Art

The proposal-acceptance process is inefficient and largely one-sided. A potential buyer, typically of services, provides a request for proposal (“RFP”). The RFP typically provides information on the general nature of the desired service (or product). In response, a number of potential sellers provide proposals. The work expended upon these proposals may be enormous. Depending upon the desired service (or product), hours of time by multiple individuals may be required to prepare even a passable proposal.

Alternatively, potential sellers may feel that the competition is so voluminous and the likelihood of successfully obtaining acceptance of an offer and subsequent payment for the offer so small that potential sellers may self-eliminate. This self-elimination may take the form of a woefully inadequate proposal or a complete lack of a response to an RFP. This self-elimination may be in spite of the potential sellers having valuable expertise or ideas relevant to the RFP.

Subsequently, buyers will select the best proposal and will award a contract for the work to that seller. All work and all payment for work will be allocated to a single seller, despite the buyer's receipt of multiple, potentially-valuable proposals for a given service (or product).

The risk/reward ratio table for a two-phase transaction from the perspective of a buyer is presented below:

TABLE 1

| | Funds | Total | Likelihood of | | |
|---|---|---|---|---|---|
| Phases | Added | Funds | RFP Award | Total Budget | Reward |
| (PH) | (FA) | (TF) | (PL = PH/NP) | (B) | (R = B * S) |
| 1 | 0 | $0 | 50% | $300 | 150 |
| 2 | 300 | $300 | 100% | $300 | 150 |

TABLE 2

| Adjusted | | | | | |
|---|---|---|---|---|---|
| Potential | Time | | Cost of Time | Risk | Risk/Reward |
| Reward | Spent | Rate | (CT = | (RI = | Ratio |
| (AR = PL * R) | (TS) | (RH) | TS * RH) | FA + CT) | (RA = RI/R) |
| $75.00 | 1.65 | $25 | 41.25 | 41.25 | 28% |
| $150.00 | 0.5 | $25 | 12.5 | 312.5 | 208% |

As can be seen, the risk/reward ratio before the project is awarded is a mere 28% for the buyer—he or she holds all of the money and is making a request without putting any of the money up for the job. Whereas, after the request has been awarded, indicating that the buyer has selected the seller to complete the project, the risk swings back to 208% against the buyer. S, here, is an estimate of the savings the buyer receives over merely purchasing the project on the open market.

In contrast, an example of a risk/reward table for a typical $300 request for proposal from a seller's perspective is reproduced below:

TABLE 3

| | | | | Weighted | |
|---|---|---|---|---|---|
| | | Cost of | Competing | Potential | Seller's |
| | Seller | Time | Sellers | Profit | Risk/Reward |
| Seller Time | Hourly | (SCT = | (CS = | (WP = | Ratio |
| (STS) | Rate (STH) | STS * STH) | 1 + (TA/AC)) | AR/CS) | SRA = SCT/WP |
| 1.1 | $25 | 27.5 | 4 | $18.75 | 147% |

As can be seen, the risk/reward ratio is very high, at 147%, before the request has been awarded.

As a result, this traditional RFP process creates incentives for buyers to abuse sellers—intentionally seeking mass input from many viable sellers' proposals. The buyer is out no money or time and, in most instances, need not select any of the resulting proposals. In contrast to the buyer, the seller has virtually no power within the RFP process. The seller is at the whim of the buyer and, often, has virtually no feedback from or information about the buyer or the RFP. However, once a bid is accepted in a typical scenario, the seller may now deliver a poor result and the buyer has limited recourse and limited interaction from the seller other than to completely withhold payment. However, this is inadvisable as it will likely ruin the relationship and not encourage collaboration to create a viable result.

### DESCRIPTION OF THE DRAWINGS

FIG. 1 is a block diagram of an environment for processing requests for proposals.

FIG. 2 is a block diagram of a computing device.

FIG. 3 is a block diagram of a system for processing requests for proposals.

FIG. 4 is a flowchart for processing requests for proposals from a buyer's perspective.

FIG. 5 is a flowchart for processing requests for proposals from a seller's perspective.

FIG. 6 is an abstraction of a user interface for viewing a request for proposals.

FIG. 7 is an abstraction of a user interface for processing requests for proposals as seen from a buyer's perspective.

FIG. 8 is an abstraction of a user interface for processing requests for proposals as seen from a seller's perspective.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

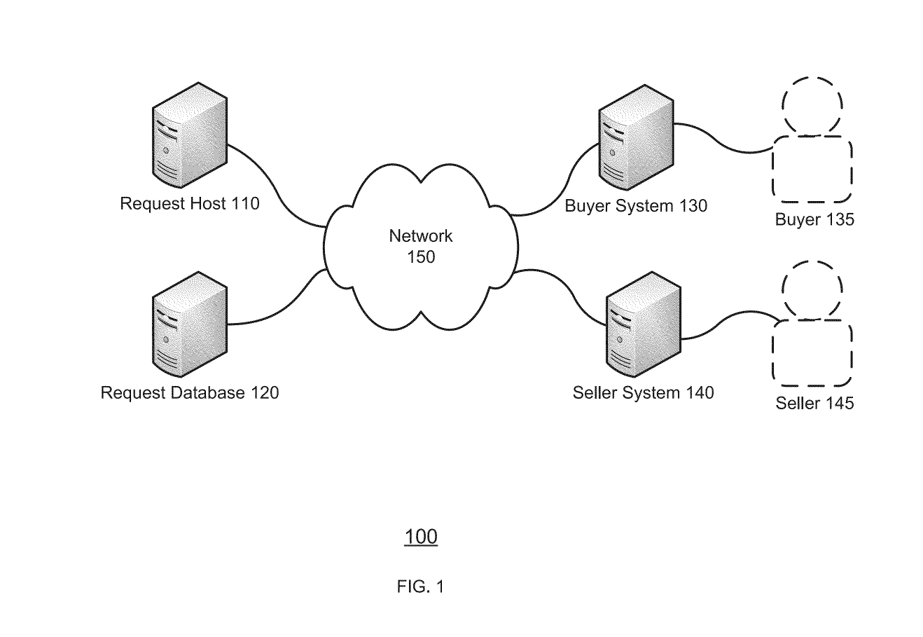

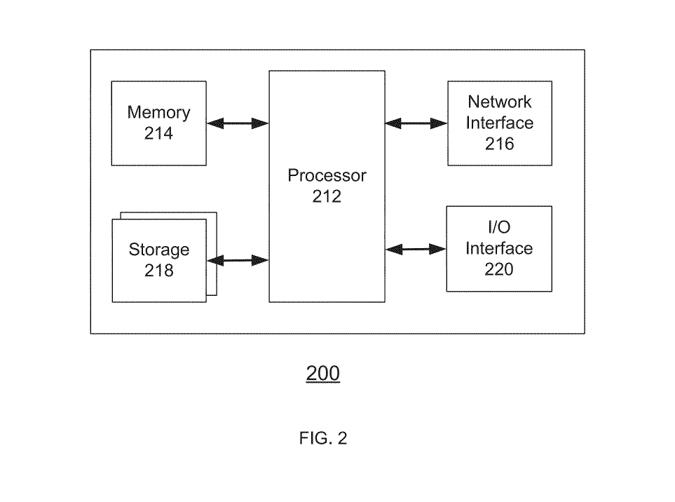

Referring now to FIG. 1, there is shown a block diagram of an environment 100 for processing requests for proposals. The environment 100 includes a request host 110, a request database 120, a buyer system 130, and a seller system 140. The buyer system 130 is operated by a buyer 135 and the seller system 140 is operated by a seller 145. The environment 100 may be implemented using distributed computing and interconnected by the network 150. Each of the request host 110, request database 120, buyer system 130 and seller system 140 are computing devices described below with reference to FIG. 2.

The request host 110 is a computer, group of computers, mobile device, tablet or similar computing device that host requests for proposals. The request host 110 is generally accessible, via the network 150, to buyers to enable generating requests for proposals and to sellers to enable responses to those requests. The request host 110 may be or include software operating as a web server. The request host 110 may be or include software operating as an application server, capable of responding to interaction with remote application software operating on either the buyer system 130 or the seller system 140. The request host 110 may also include software capable of processing escrow receipts from the seller system 140 and to cause escrow release as directed by the buyer system 130.

A “request” in this patent is a “request for proposal” or a “request for bids.” The “request” is an offer to pay an individual to provide a service or a product. However, a “request” in this patent is dynamic such that the request includes both a maximum bid and a current level of funding for the request. The current level of funding is present in an escrow account associated with the bid. The buyer may pre-fund the request. This optional pre-funding may encourage participation by sellers in response to the request, because it demonstrates seriousness about the request and the current level of potential financial remuneration for the seller's involvement in the request.

The request database 120 is a computer, group of computers, mobile device, tablet or similar computing device that includes software comprising a database of requests and associated bids. The request database 120 may be a part of the request host 110 or may be stored and operated in a distinct computing environment from that of the request host 110. In FIG. 1, the request database 120 is shown as separate from the request host 110. The request database 120 includes database software that stores data pertaining to requests, associated descriptions of those requests, the status of any escrow account associated with a given request, any communication between buyers and sellers and any bids associated with a given request.

The buyer system 130 is a computer, group of computers, mobile device, tablet or similar computing device that is used by the buyer 135 to access the request host 110 in order to participate in responses to requests. The buyer system 130 may incorporate software comprising a web browser, a mobile application, a web page or application widget, or an application. The buyer system 130 communicates with the request host 110 in order to interact with hosted requests and the request data stored in the request database 120.

The “buyer” in this patent is the party making a request for a proposal. The buyer “buys” products or services from one or more sellers who have responded to the request for proposal.

The seller system 140 is a computer, group of computers, mobile device, tablet or similar computing device that is used by the seller 145 to access the request host 110 in order to create requests for proposals and to interact with potential participants or on-going requests. The seller system 140 may incorporate software comprising a web browser, a mobile application, a web page or application widget, or an application. The seller system 140 communicates with the request host 110 in order to interact with hosted requests and the request data stored in the request database 120.

The “seller” in this patent is a party making a response to the request for a proposal made by a seller. This response may take many forms. The response may be a completed project called for by the request. The response may be feedback on the project. The response may be a bid made by the seller. The “bid” is an offer to complete the project at a specific price. A “potential seller” or “offeree” is a seller who has participated in the RFP process, but has not yet been awarded the project by a buyer.

The network 150 may be or include a local area network, a wide area network, wireless networks and the Internet. The network 150 interconnects the request host 110, the request database 120, the buyer system 130, and the seller system 140. The network 150 enables communication of data between the various interconnected elements. The network 150 may provide access to additional, outside services such as an Internet-based escrow service.

Turning now to FIG. 2, there is shown a block diagram of a computing device 200, which is representative of the server systems, client systems, mobile devices and other computing devices discussed herein. These include, for example, the request host 110, the buyer system 130 and seller system 140 of FIG. 1. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 212 coupled to a memory 214, storage 218, a network interface 216 and an I/O interface 220. The processor 212 may be or include one or more microprocessors, field programmable gate arrays (FPGAs), application specific integrated circuits (ASICs), programmable logic devices (PLDs) and programmable logic arrays (PLAs).

The memory 214 may be or include RAM, ROM, DRAM, SRAM and MRAM, and may include firmware, such as static data or fixed instructions, BIOS, system functions, configuration data, and other routines used during the operation of the computing device 200 and processor 212. The memory 214 also provides a storage area for data and instructions associated with applications and data handled by the processor 212.

The storage 218 provides non-volatile, bulk or long term storage of data or instructions in the computing device 200. The storage 218 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term “storage medium” corresponds to the storage 218 and does not include transitory media such as signals or waveforms. In some cases, such as those involving solid state memory devices, the memory 214 and storage 218 may be a single device.

The network interface 216 includes an interface to a network such as network 150 (FIG. 1).

The I/O interface 220 interfaces the processor 212 to peripherals (not shown) such as displays, keyboards and USB devices.

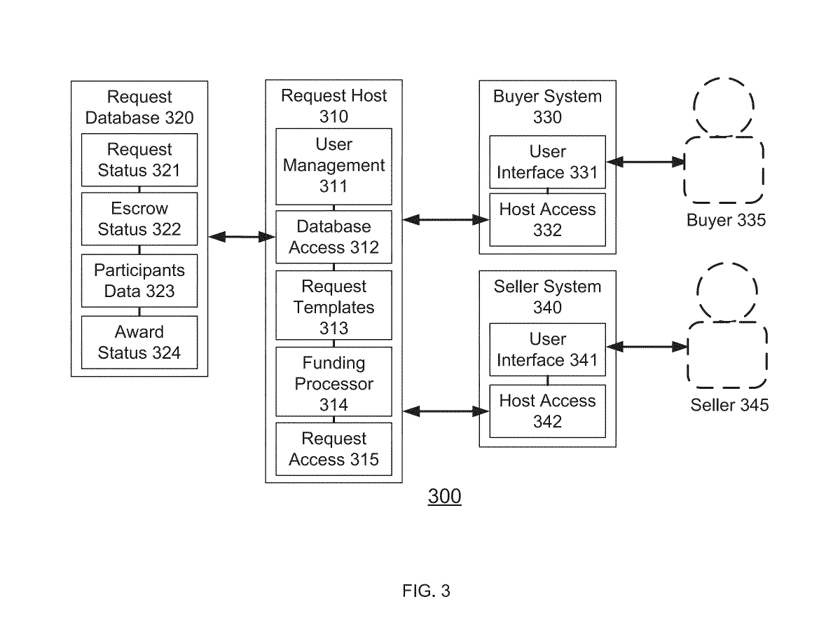

FIG. 3 is a block diagram of a system 300 for processing requests for proposals. FIG. 3 includes the same request host 310, request database 320, buyer system 330 and seller system 340 as FIG. 1 (110, 120, 130 and 140, respectively).

The request host 310 includes user management 311, database access 312, request templates 313, a funding processor 314, and request access 315. The user management 311 includes user management functions such as user registration, in addition to user login and logout. The user management 311 also includes maintaining profiles and participation history for both buyers and sellers.

The database access 312 enables the request host 310 to communicate data with the request database 320. The request host 310 requires access to the request database 320 in order to manage the process of creating, interacting with and completing requests. The functions of the request database 320 are discussed more fully below.

The request host 310 may also include request templates 313 that enable a buyer, such as buyer 335, to create a request. The request may be hosted by the request host 310 as a web page or as a sub-section within an application or mobile application. There may be varying types of requests. For example, a buyer may desire a new logo for his or her website or may desire a physical product, such as a sculpture, painting or other object, be created. There may be templates stored in the request templates 313 that may be used by buyers for various types of requests.

The funding processor 314 includes the capability to receive funding from buyers, such as the buyer 335, through interaction with the buyer system 330. For example, this funding processor may accept credit card processing, bank account access, a third party escrow service, online electronic payment services, third party payment services, electronic currencies, payment processing services, or may rely upon a points-based system where a user purchases points for use in the request process that may later be redeemed for cash. The funding processor 314 also enables distribution of funds to sellers, such as seller 345, through the seller system 340. This may also take place via credit card processing, bank account access, the use of a third party escrow service, a payment processing service or may rely upon a points-based system where a user purchases points for use in the request process that may later be redeemed for cash.

The request host 310 also includes the request access 315. In instances in which requests are generated or accessed via an interactive website, this request access 315 may be, in part, a web server application. In instances in which the requests are generated and accessed via an application, mobile application or web “widget,” this request access 315 may be or include a web server application or an application programming interface (API) whereby the applications may interact with the request host 310 to generate, view, edit, comment on, provide payment to, and receive payment for requests.

The request database 320 includes data such as request status 321, escrow status 322, participants data 323 and award status 324. The request status 321 is one example of the type of data that the request database 320 stores. The request status 321 includes the current status of one or more requests hosted by the request host 310. This status may include the current maximum bid allowed by a buyer, the current high bid and all other bids by potential sellers, the description of the request and the collection of any feedback and any files provided relating to any requests. The maximum bid may be set by a buyer, but is not necessarily a hard cap on the maximum bid. It may be or it may not be, depending on the settings of the request database set by an administrator.

The request status 321 may also include the overall point in the process for each request within the request database 320. These statuses may include, for example, statuses of: “open,” a period during which a request is open for bidding, “awaiting selection,” a period during which a buyer must pick a winning seller, “bidder selected,” a period during which a proof must be accepted, “proof accepted,” a period during which the final product must be provided, “product uploaded,” a period during which the final product must be accepted (or rejected) by a buyer, “product approved,” a period during which the buyer has indicated acceptance of the project, “closed paid,” a period during which the funds have been released to the seller after delivery of the project, and “no winner,” for a project for which no seller was selected and no funds were released.

The escrow status 322 maintains data pertaining to the current status of the escrow associated with one or more requests. The escrow status may also maintain sufficient data to enable the request host 310 to access an external escrow service for purposes of adding money to an escrow account and for purposes of releasing money from escrow to a seller who has been awarded a request. Alternatively, the escrow service may be maintained as a part of the request database 320 (or request host 310) in which case the escrow status 322 may be maintained along with the financial information necessary to act as an escrow service.

The participants data 323 is a portion of the request database 320 storing data pertaining to sellers and buyers. For example, the participants data 323 may include a history of all interactions with the site and/or application (or all interactions for a predetermined history). Sellers and buyers who interact with each other may provide feedback regarding RFPs, the results of RFPs, and general interactions with one another. These results may form a “reputation score” that is associated with either a buyer or a seller. This score may form a part of the participants data 323 and may be referred to by buyers or sellers in the process of determining whether or not to participate in a given RFP. The participants data 323 may also indicate all current RFPs and bids related to a given buyer or seller.

The award status 324 is a portion of the request database 320 that stores data pertaining to the award status of bids for RFPs. For example, the award status 324 may be either awarded or not-awarded for any given RFP. If the award status 324 is awarded for a given RFP, then the award status 324 will further include the username of the associated seller to whom the bid has been awarded and the amount of that bid. If a given RFP has not been awarded, then the award status 324 may indicate the current level of bids (and associated usernames of sellers) for that RFP. The buyer of any RFP is also associated with the RFP in the award status 324 portion of the request database 320.

The buyer system 330, used by a buyer 335, includes a user interface 331 and host access 332. The seller system 340, used by the seller 345, includes a similar user interface 341 and host access 342. Both the buyer system 330 and the seller system 340 are computers, which include software including a user interfaces 331 and 341, and host access 332 and 342 that enable the systems 330 and 340 to access the request host 310. The user interfaces 331 and 341 may be web browser software, a mobile application, a portion of a web page (such as a widget that may be inserted in the form of an embedded object), a desktop application or other, similar software. The user interfaces 331 and 341 enable a user, either the buyer 335 or the seller 345, to use the respective buyer system 330 and seller system 340 in order to interact with the request host 310.

The host access 332 and 342 may be or include a network stack used to transmit data between the buyer system 330 or seller system 340 and the request host 310 regarding requests. The host access 332 and 342 may also be or include an application programming interface (API) that is used to enable the buyer system 330 and the seller system 340 to communicate directly with the request host 310 regarding requests.

The buyer 335 and seller 345 represent buyers and sellers that utilize the system 300 to create, interact with and award to requests.

Description of Processes

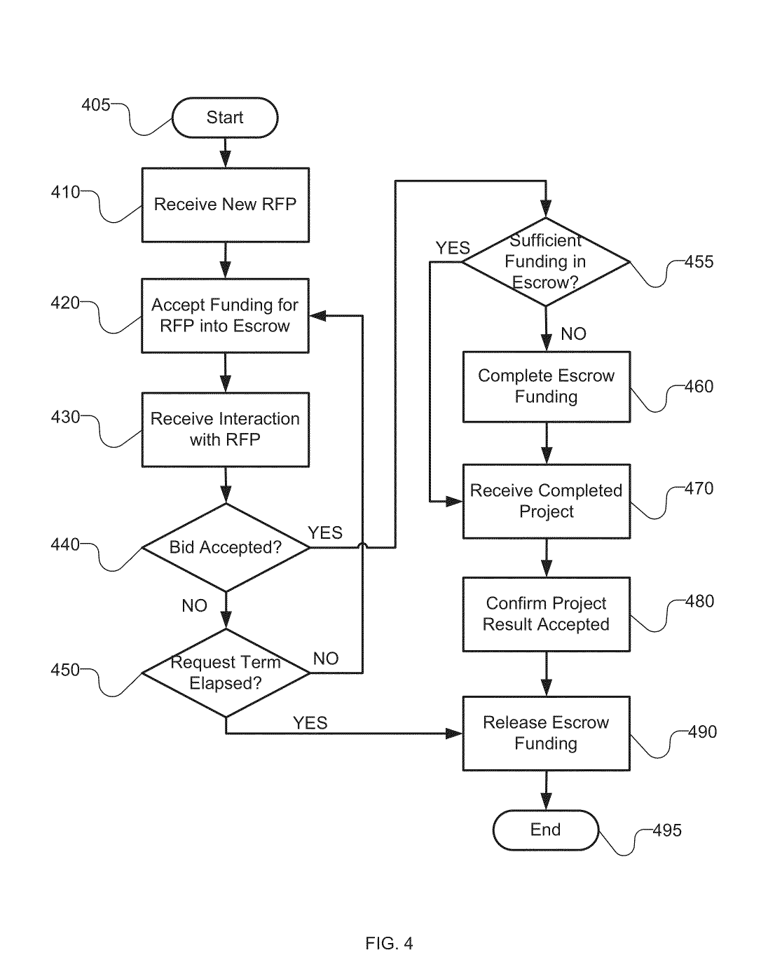

Referring now to FIG. 4, a flowchart for processing requests for proposals from a buyer's perspective is shown. The flow chart has both a start 405 and an end 495, but the process may be cyclical in nature. Many instances of the process may take place serially or in parallel. The process takes place through interaction, as described in FIG. 4, with a request host, such as request host 310, while storing data in a request database such as the request database 320. One algorithm used by the request host 310 in interaction with the request database 320, the buyer system 330 and the seller system 340 is reflected in FIG. 4 and the accompanying description below.

The process begins with the receipt of a new RFP at 410 from a buyer. The new request for proposal may be input via a web-based, software-based or widget interface utilizing a plurality of inputs, such as text boxes, dropdown menus and selectors. The interface may include inputs that allow a buyer to type a description of the project for which a request is being made, to input or select a maximum bid for the project and to input other relevant information such as the individual or group making the request. The buyer will also input a term for the RFP. The term, discussed more fully below, may act as a deadline for acceptance of one of the bids input by potential sellers in response to the RFP.

The buyer may also input other rules of the request, such as milestones, payment distribution rules related to which seller or sellers are paid and in what percentages of the escrow, deliverable materials, the form of the completed project, any internal deadlines or timelines, or any other requirements of the RFP.

In most cases, a buyer or seller will be required to login to the system to create the RFP, thereby eliminating the need to input relevant information regarding the individual or group at the time of request creation. That information will be collected at login-creation. Over time, the individual or group associated with the request will create a history of involvement with the system and potential sellers will be able to review that history as a part of making a determination as to whether or not to proceed with a bid on a given request. In addition, this profile includes contact information and, potentially, a payment history for prior requests.

Once the RFP is received, a first round of funding is accepted for the RFP at 420. The RFP may or may not be posted to the request host 310 or visible to any potential sellers before a first round of funding is accepted at 420. This initial funding serves to demonstrate that the buyer is serious about the request and begins the process of mutual commitment to the request on the part of the buyer and the seller. In some cases, an initial funding for the RFP need not be required. The addition of funding into the request may also cause the money submitted to be irretrievable (except, perhaps, in unusual circumstances) by the buyer. This serves to ensure to potential sellers that the money related to the request will be distributed when the process is complete, regardless of whether the bid is awarded by the buyer.

Next, the system may receive interaction with the RFP at 430. This interaction is typically first from one or more potential sellers to the buyer. The participation may be, for example, in the form of a question posed to the buyer relating to the RFP. These questions may be posted on the web page or application screen associated with the request. The buyer may then interact with the potential sellers by responding to the question or by updating the RFP. The interaction takes place through the website (or application) and is logged on the website (or application) so as to encourage collaboration between the buyer and potential sellers.

The interaction may also include one or more of the potential sellers providing a “bid” for the project. For example, assume a buyer has indicated that he or she is willing to pay a maximum of $500 for a seller to provide a new logo for a website redesign. A seller then may “bid” that he or she is willing to complete the project for $300. Though this may be the lowest bid that the buyer receives for the project, the buyer may review the potential seller's feedback, prior history of involvement with other requests (and related work product) from the seller's profile and determine that the buyer would prefer not to work with that seller. Instead, the buyer may choose a different seller who has a higher bid, but who also has a better or more extensive history or because that seller has given very relevant feedback, commentary, a very good proof of concept, or has a very convincing professional portfolio. That seller may also have provided proofs or mock ups of a potential final logo that is most appealing to the buyer.

At 440, a determination is made as to whether the buyer has accepted the bid. If the buyer has not accepted the bid of one of the potential sellers, then a determination is made whether the term of the RFP has elapsed at 450. Elapsing of a project term may take many forms. For example, a predetermined time-period or deadline for the project may end the term, the buyer's decision to end the project early may end the term, if the buyer ceases to interact with the project for a predetermined period of time, this may trigger the end of the term, or if a seller is awarded and/or completes the project, but the buyer fails to complete the request process the term may elapse.

As an incentive for the buyer to select a potential seller, the funding available in escrow may be released to all participating potential sellers at 490 in response to the request term elapsing at 450. The release may also be subject to a fee provided to a listing agent out of the funds in escrow. For example, the listing agent may take a flat fee or a percentage of the funds in escrow as payment for hosting the RFP. The “listing agent” as used herein is an individual or entity that provides access to the system in which the RFP is hosted.

This release at 490 may also be subject to a predetermined rule set. For example, all potential sellers who have posted more than one comment may receive an equal share of the funding then-currently in escrow at the end of the term. Alternatively, all potential sellers who have submitted one example potential response to the RFP (such as a proof of concept) may receive a share of the funding in escrow as defined by the payment distribution rules of the RFP. Still further alternatively, the two most-active potential sellers may split the funding then-currently in escrow. If the project has been awarded to a single seller or if a seller has completed the project, then the elapsing of the term may result in that seller receiving most or all of the funds in escrow. Numerous alternatives exist for ways in which to split the funding then-currently in escrow. These rules regarding splits may be, for example, based upon the total number of responses, quality of responses, overall performance in fulfilling the request or other, similar, measures. The alternatives may be set by the operator of the request host or may be buyer or seller-set. Buyers or sellers may base their decisions of whether or not to submit or participate in RPFs based upon the rules for distribution of the funding at the end of the term.

The term itself may be dynamic. For example, the term may be based upon the last interaction received from one or both of the buyer and seller. As a result, the term for a given request may elapse when no interaction from, for example, the buyer has been made within the last week. Interaction by a buyer (or seller) in that period may automatically reset the term. Alternatively, if no interaction with any potential seller has been received within the last week, then the term may elapse with all funding being returned to the buyer. A lack of interaction from potential sellers may indicate that no seller is interested in fulfilling the project and, as a result, it may be unfair to allocate funds among potential sellers who have participated, but are not working toward completing the request.

If the term has not elapsed at 450, further funding may be accepted at 420. At this stage, interaction was already received at 430 and, in order to demonstrate continued involvement and intent to follow through with fulfilling the request, the buyer may further fund the escrow account associated with the RFP at 420. The current status of the escrow account may be shown on the web page or application screen associated with the request. Further funding demonstrates to potential sellers that the buyer is still actively seeking a seller to whom to award the project. In addition, increased funding may prompt still more potential sellers to take interest in the project. In response to the additional funding or as the request progresses, additional buyer and potential seller interaction may be received at 430. This interaction and increased funding may iterate a number of times before a buyer accepts a potential seller's bid.

Once a bid is accepted at 440, then a determination is made at 460 as to whether there is sufficient funding in escrow to cover the cost of the potential sellers winning bid. A buyer may have indicated a willingness to pay $500, but the bidder may have only bid the project at $300. However, the escrow account may currently only hold $250. If this is the case, and there is not sufficient funding in escrow at 460, then the buyer will be asked to complete the escrow funding process at 470 by adding additional funds to the escrow.

If there already are sufficient funds in escrow at 460 or once the funding is completed at 470, the system will request and receive the completed project from the selected seller at 470 for review by a buyer. The buyer then confirms that the completed project is accepted at 480. This completed project must satisfy the terms that were defined when the request was made by the buyer and be fulfilled within the time-frame allotted. This may involve uploading a final image of a logo, completing the redesign of the website or creating the desired product.

This confirmation process may involve communication or feedback regarding the completed project and may require limited additional interaction between the buyer and seller. In other cases, this process may involve substantial additional work on the part of the seller in order to meet the requirements of the terms of the request. This may involve several iterations requiring multiple interactions of the buyer and seller (and potentially other participants in the request) or may be merely a quality check by the buyer.

During confirmation, the website, application or widget associated with the RFP may incorporate all materials related to the project publicly so that other potential sellers can see the progress. The process of completing the project may be visible to other sellers accessing the request host or may occur privately through direct interaction between only the awarded seller and buyer. In some cases, only a part of a project (such as the bid or the final result) may be visible to buyers (or others) on the seller's profile. Some or all of the completed project and related materials may serve to enhance user profiles associated with the buyer and the seller.

Once the completed project is confirmed by the buyer at 480, the funds in escrow may be released at 490 to the seller or, depending on the terms of the request, to the seller and one or more participants in the bidding process and/or to a listing agent. The process then ends at 495.

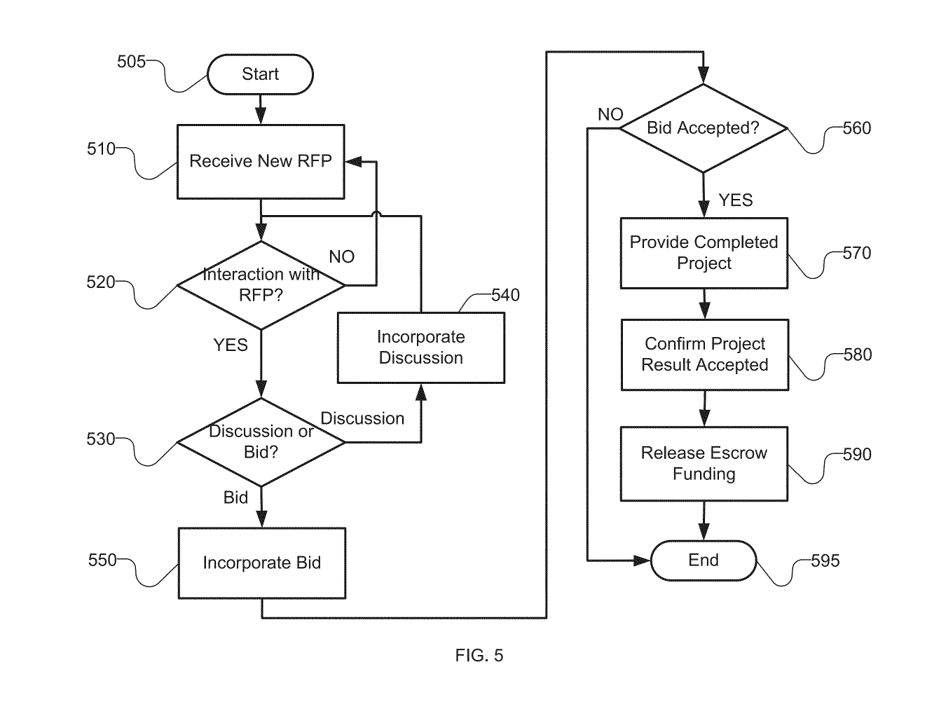

FIG. 5 is a flowchart for processing requests for proposals from a seller's perspective. The flow chart has both a start 505 and an end 595, but the process may be cyclical in nature. Many instances of the process may take place serially or in parallel. The process takes place through interaction, as described in FIG. 5, with a request host, such as request host 310, while storing data in a request database such as the request database 320. One algorithm used by the request host 310 in interaction with the request database 320, the buyer system 330 and the seller system 340 is reflected in FIG. 5 and the accompanying description below.

The process begins at receipt of a new RFP 510 when a buyer posts a new RFP which appears in a seller's web browser, application, or similar interface. The RFP may have metatags, meta descriptions, searchable descriptive information, categories or other forms of a general type of RFP associated with it, as input by the buyer, to aid a seller in determining whether he or she may be interested in participating in the bidding process. The seller's interface with the request host 310 may automatically identify relevant, new RFPs that the seller may be interested in based, in part, upon the general type identified by a buyer and skill, interest data or past RFP interaction history stored as a part of a seller profile by the request host 310.

The seller may then decide whether or not to interact with the RFP at 520. This interaction may take the form of a bid, feedback regarding the RFP, work on the request, additional work product related to the request or other, related interaction. If no interaction is received, the seller may await receipt of a new RFP at 510.

If interaction is received by the request host 310, then a determination is made as to whether that interaction is a discussion or bid at 530. All interaction other than a bid is considered discussion. If the interaction is a discussion at 530, then the discussion is incorporated into the request at 540. This discussion may include the providing of proofs or rough ideas of a response to the RFP. All interaction, including the discussion, may be incorporated into the web page, application screen or widget associated with the request. In this way, all potential sellers participating in the request have access to all material related to the request. Alternatively, some interaction associated with the request may be stored and accessible on the web page while other interaction directly between a potential seller and a buyer may be kept private from other sellers.

If the interaction is a bid at 530, then the bid is incorporated into the request 550. This process may include updating a graphic, on the website or within the application or widget, pertaining to the size of the bids of potential sellers. This process also alerts the buyer and, potentially, other sellers as to the amount of the bid along with any other content provided with the bid. Other potential sellers may take part in this process as well. Those potential sellers are given the same opportunity to discuss and bid on a given RFP. A potential seller may be given the opportunity to alter a bid. For example, if through discussion, a buyer has indicated that the desired result of the RFP is more complex than initially understood by a potential seller, the potential seller may then choose to increase his or her bid. Similarly, if the project is found to be even more simple than initially understood, a potential seller may be able to decrease his or her bid. However, decreases in bids may be disallowed in some or all cases in order to encourage collaboration, careful bidding on RFPs and to discourage a, so-called, “race to the bottom” in bidding. Further, minimum bid amounts may be predetermined by a system administrator or the current funding level may be used to set a dynamic minimum bid. In such a case, bids below the current funding level may be rejected. This may serve to indicate to potential sellers that the current funding level, at least, will be distributed.

If a potential seller's bid is not accepted at 560, then the process effectively ends as to that potential seller at 595. If the potential seller's bid is accepted at 560, then the seller submits the completed project to the request host at 570. This submission may be facilitated or completely enabled by the request host 310. For example, if the RFP was a request to complete a logo for a website, then the request host 310 may provide the capability to accept files, including concepts, proofs and, eventually, the completed final of the logo directly from the seller.

Once submitted by the seller and received by the request host 310, then the request host 310 can confirm that the project result has been accepted at 580. The request host 310 provides the project to the buyer for review and enables the buyer to provide feedback to the seller. In some cases, the seller may provide a proof of the project (for example a watermarked file) for approval before providing the final product. In some situations, facilitation of acceptance by the buyer may be difficult. In situations in which the request is for a tangible object to be created, the request host 310 may not be able to independently confirm that the project result has been accepted. In these situations, the seller may indicate, using the request host 310, that the project result has been completed. Then, the buyer may be asked to independently confirm that the project result is accepted at 580.

Under either scenario, once a project result has been confirmed as accepted at 580, the funding in escrow will be released to the chosen seller (subject to any fees to a listing agent) at 590. This may involve the release of funds directly to an account added by the seller or associated with the seller. This release may take the form of a credit to an account, a check, a money order or other, electronic payment, electronic currency, or other, similar payment that may be automated to the extent possible and facilitated by the request host 310. The funds released may be subject to any associated listing agent fee as discussed above.

Because FIG. 5 shows the situation in which the bid is accepted at 560, the alternative situation in which the funds in escrow are distributed in shares to participants (as described in FIG. 4) is not shown. Once the funds are released at 590, the process ends.

The results of FIGS. 4 and 5 may be seen by way of an example of a $300 RFP set forth in tables 4 and 5 below. Table 4 is the $300 RFP as seen from the perspective of a buyer:

TABLE 4

| | | Total | Likelihood of | |
|---|---|---|---|---|
| Phases | Funds | Funds | RFP Award | Risk/Reward Ratio |
| (PH) | Added (FA) | (TF) | (PL = PH/NP) | (RA = RI/R) |
| 1 | $0 | $0 | 9% | 4% |
| 2 | $30 | $30 | 18% | 22% |
| 3 | $30 | $60 | 27% | 22% |
| 4 | $30 | $90 | 36% | 22% |
| 5 | $30 | $120 | 45% | 22% |
| 6 | $30 | $150 | 55% | 22% |
| 7 | $30 | $180 | 64% | 22% |
| 8 | $30 | $210 | 73% | 22% |
| 9 | $30 | $240 | 82% | 22% |
| 10 | $30 | $270 | 91% | 22% |
| 11 | $30 | $300 | 100% | 28% |
| | | | Avg % | 20.68% |

Table 4 is similar to Tables 1 and 2 above, but some portions of those tables are omitted in the interest of brevity. As can be seen, the risk/reward ratio as the project progresses through many phases of interaction, bidding, feedback and proofs is more consistent while increasing the likelihood that the project will be awarded at each phase as more money is added by the buyer.

Table 5 is an example of a risk/reward table for the same $300 RFP of Table 4 as seen from a seller's perspective:

TABLE 5

| | | | | Weighted | |
|---|---|---|---|---|---|
| | | Cost of | Competing | Potential | Seller's |
| | Seller | Time | Sellers | Profit | Risk/Reward |
| | Hourly | (SCT = | (CS = | (WP = | Ratio |
| Phases (PH) | Rate (STH) | STS * STH) | 1 + (TA/AC)) | AR/CS) | SRA = SCT/WP |
| 1 | $25 | 2.5 | 1 | $13.64 | 18% |
| 2 | $25 | 2.5 | 1 | $20.98 | 12% |
| 3 | $25 | 2.5 | 2 | $25.57 | 10% |
| 4 | $25 | 2.5 | 2 | $28.71 | 9% |
| 5 | $25 | 2.5 | 2 | $30.99 | 8% |
| 6 | $25 | 2.5 | 3 | $32.73 | 8% |
| 7 | $25 | 2.5 | 3 | $34.09 | 7% |
| 8 | $25 | 2.5 | 3 | $35.19 | 7% |
| 9 | $25 | 2.5 | 3 | $36.10 | 7% |
| 10 | $25 | 2.5 | 4 | $36.86 | 7% |
| 11 | $25 | 2.5 | 4 | $37.50 | 7% |
| | | | | Avg % | 9.20% |

As can be seen, the risk/reward ratio for the seller begins at 18%, but decreases as the project moves on, even though other sellers have entered the bidding. The disparity between the risk/reward ratio moves from 100% or more (as shown in Tables 1-3 above) to less than 10% throughout the entire process (as shown in Tables 4 and 5). Thus, the system described herein reduces the risk/reward ratio disparity for buyers and sellers in a typical RFP scenario.

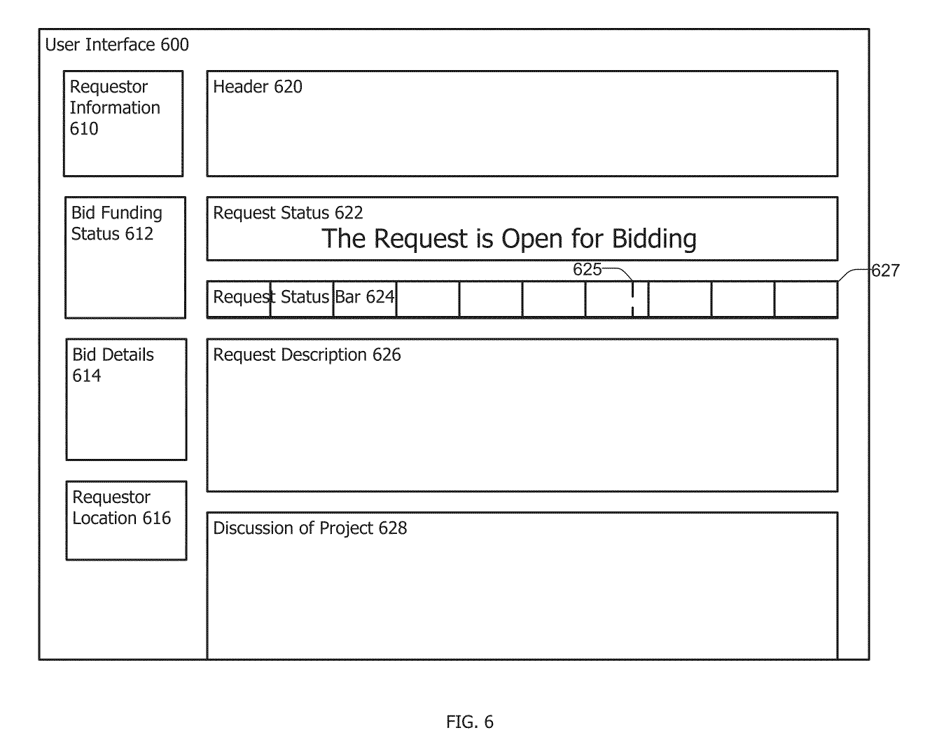

FIG. 6 is an abstraction of a user interface 600 for viewing a request for proposals. As mentioned above, this user interface 600 may be presented as a web page accessed via a web browser, as an application operating, for example, on a mobile device, a desktop computer or a tablet, or as a portion of any of these. The web browser may be a part of an application that displays the user interface 600.

The user interface 600 includes the requestor information 610. This may be a username, an image associated with the username, and/or a link to a profile associated with the username. This username is that of the requestor (or buyer) who has created the request. This requestor information 610 may be accessed by a potential seller to view a history of other requests that the buyer has made or in which the buyer has otherwise been a participant. The requestor information may also include links to websites associated with the requestor, including a home page, social media pages, requestor profiles on other sites and similar information.

The user interface 600 also includes a bid funding status box 612. The bid funding status box 612 may indicate the maximum allowable bid for the request as input by the buyer and the current maximum bid input by any one of the potential sellers. As discussed above, the maximum is set by a buyer, but a seller may bid more than the maximum in some cases. The bid funding status box 612 may also indicate the current level of funding in escrow for the request and may indicate a time at which the request lapses and the funding will be dispersed if a bid is not accepted. In this way, a newcomer to the request, such as another potential seller, can quickly determine whether or not participating in this request may be profitable.

The user interface 600 also includes bid details 614, which may indicate all of the bids that have been made, the associated sellers making those bids (which may be links to profiles of those potential sellers) and the value of those bids. This information may be useful to a buyer in choosing between potential sellers. The requestor location 616 may indicate the location where the requestor is from. This may be relevant in cases in which the request pertains to services that must be rendered in person. A potential seller or buyer may not be interested in participating in or in choosing participants from other cities or states who may have difficulty fulfilling the request as a result. The request host 310 may automatically filter these requests from the view of potential sellers who so direct or buyers who so request.

The user interface 600 includes a header 620 that may be system-specific or request-specific. For example, a system-specific header may identify the service facilitating the RFP process described herein. A request-specific header may be a header, uploaded by the buyer, identifying the entity for whom the request is being made. For example, the header may be a corporate logo for a company making the RFP.

The user interface 600 also includes a request status bar 622. The request status bar 622 indicates whether or not the request is currently available for potential seller interaction or if it is no longer active. The request status bar 624 may serve as a measure of the current high bid 625, relative to the maximum bid 627. In this way, a potential seller can see at a glance whether the buyer has added funding that will be available to participants in the request, regardless of whether a bid is accepted. This may serve to encourage or discourage potential seller involvement. The bids by various potential sellers may also be simultaneously displayed along with a username. Alternately, the bids by potential sellers may only be displayed to a buyer.

Next, the user interface 600 includes a request description 626. This is information input by a buyer regarding the details of the request. For example, the request description 626 may describe the type of end result desired by the request and any steps desired for a potential seller to complete the project. The discussion of the project 628 may be a time-based set of entries indicating the individual (buyer or potential seller) that made the comment or provided other feedback. The discussion of project 628 may include uploaded files, commentary, feedback, proofs of documents or similar items. A new potential seller and the buyer will, through the discussion of project 628, have access to all current information about the project and all buyer and potential seller feedback so that he or she may join in the bidding process with the full benefit of any work that has been done thus far. Private discussions between potential sellers and the buyer may also be enabled through the interface.

Anyone viewing the site (or application, or widget) who has proper permissions to be involved in the request and/or project is able to add to the discussion of project 628, for example, using a textbox built into the discussion of project 628 portion of the user interface 600. The buyer may make the entire project public when it is created, may select a subset of potential sellers who are allowed to interact, either based upon a quality score from other, past, buyers or based upon a specific number of other, satisfactorily completed projects or other information available on a seller profile. Potentially, other buyers may be barred from participating in the discussion. The discussion of project can also accept file uploads, links to other websites and similar additions to the discussion process.

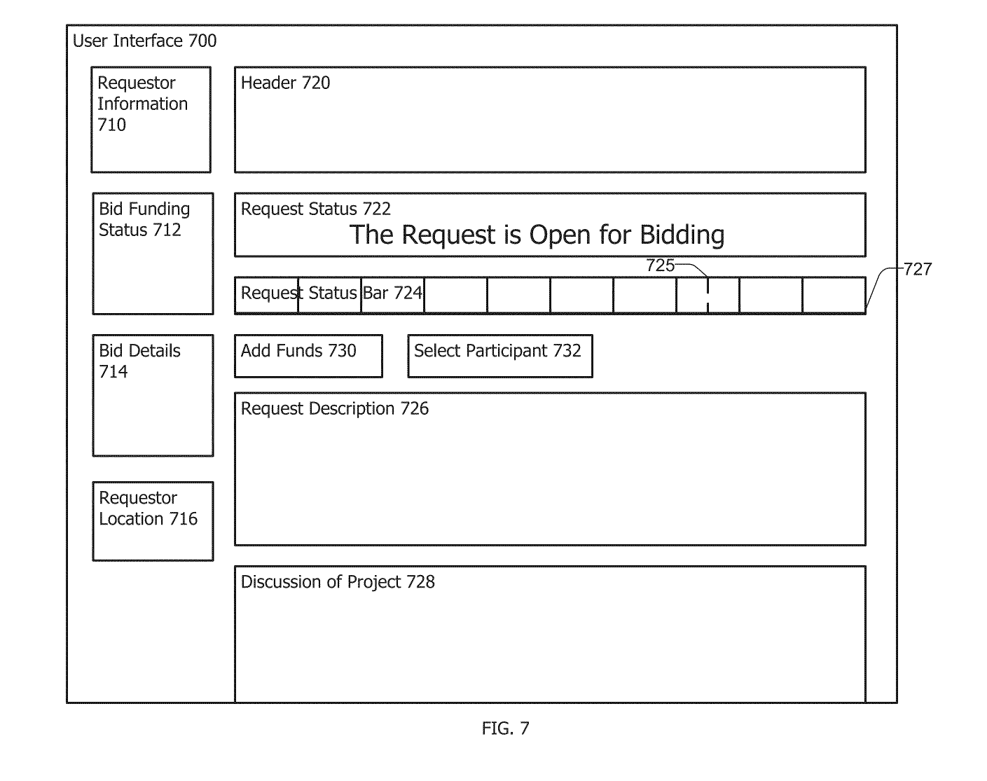

FIG. 7 is an abstraction of a user interface 700 for processing requests for proposals as seen from a requestor's perspective. The requestor information 710, bid funding status 712, bid details 714, requestor location 716, header 720, request status 722, request status bar 724 (including the current high bid 725 and maximum bid 727), along with the request for description 726 and discussion of project 728 are identical to the counterpart elements described above with respect to FIG. 6. The requestor may, however, make edits to many of these elements within certain limitations. For example, the requestor may alter or update the request description 726 as the RFP process moves forward, but cannot alter elements such as the end result of the RFP.

Sellers may be able to alter their bids for example for a certain period of time following an RFP update, including lowering or raising their bids, in response. Alternatively, the sellers may be enabled to withdraw bids or the bids may be deleted automatically if material alterations to the RFP are made after bids have been accepted. Still further alternatively, revisions to the RFP after a bid is accepted may result in the sellers whose bids were previously accepted only having to fulfill the requirements of the bid as of the time their bid was entered.

The add funds portion 730 and select participant portion 732 of the user interface 700, however, may be unique to the user interface 700 provided to a requestor. In other cases, the add funds portion 730 may be made available to anyone or to other individuals involved in the RFP process. In the add funds 730 portion of the user interface 700, the requestor may input a new amount of funding to add to the request. This add funds portion 730 may take the form of a button that brings up a dialogue box that enables receipt of funds into escrow or may take the form of a textbox into which a new amount of funds may be added with a button that enables or begins the process of providing further funding. The select participant portion 732 may be a dropdown menu along with a button for indicating a desire to select a seller. The result of using the select participant portion 732 is the selection, by the buyer, of one of the potential sellers, thus awarding that potential seller fulfillment of the request at that potential seller's current bid.

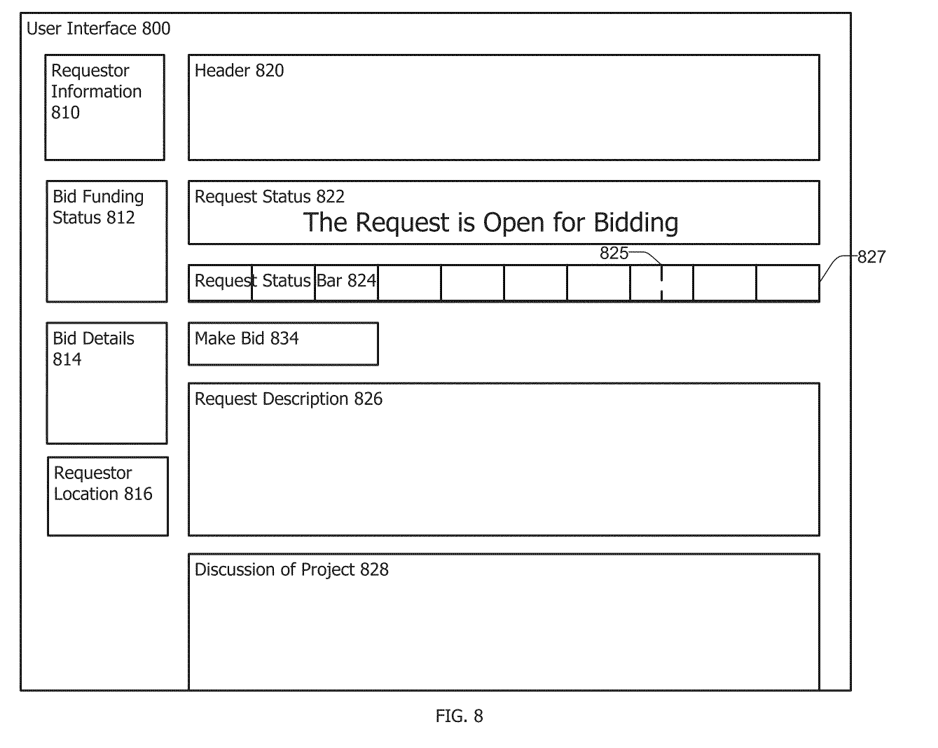

FIG. 8 is an abstraction of a user interface 800 for processing requests for proposals as seen from a participant's perspective. The requestor information 810, bid funding status 812, bid details 814, requestor location 816, header 820, request status 822, request status bar 824 (including the current high bid 825 and maximum bid 827), along with the request for description 826 and discussion of project 828 are identical to the counterpart elements described above with respect to FIG. 6. The participant (or a viewer/potential participant) may, however, not make edits to the vast majority of these elements. For example, the participant has no ability to alter or update the request description 826 as the RFP process moves forward.

The participant does have the ability to make a bid using the make bid portion 834 of the user interface 800. This make bid portion 834 may be a textbox into which a potential seller may put a number representing a bid for the request. The textbox may be associated with a button whereby the participant can submit a bid. A potential seller may alter his or her bid, by interacting with the make bid portion 834 of the user interface 800 a second time and increasing (or in some cases, decreasing) an earlier bid. In some instances, a potential seller may be required to be pre-authorized to bid. For example, a potential seller may be required to have a high reputation score or a positive rating in the system with more than a set number of (for example five) projects completed. Alternatively, a potential seller may be required to be on a list of pre-approved authorized sellers input by the buyer making the request.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method of processing requests for proposals comprising:
receiving, into a request host, a request for proposal including a project to be completed and an estimated budget for the project;
accepting funds into an escrow account in order to partially-fund the project;
receiving, into the request host, interaction with the request for proposal from a first potential seller, the interaction including a selected one of (1) discussion regarding the project, and (2) a bid on the project;
receiving, into the request host, further interaction with the request for proposal from a second potential seller, the interaction including a selected one of (1) discussion regarding the project, and (2) another bid on the project;
accepting additional funds into the escrow account in order to more fully fund the project;
determining, using the request host, that one of (1) a project award indicating that the project has been awarded or (2) a project term has lapsed; and
providing all funds in the escrow account to a group including at least one of the first potential seller, the second potential seller, and a listing agent.

2. The method of claim 1 wherein the additional funds comprise funding the project to an amount bid by the first potential seller.

3. The method of claim 1 further comprising:
receiving a bid from the first potential seller;
receiving, at the request host, a completion notification indicating that the project has been completed by the first potential seller; and
providing all funds in the escrow account to the group, wherein the group includes at least one of the first potential seller and the listing agent.

4. The method of claim 3 further comprising receiving, at the request host, an indication that the bid has been accepted prior to receiving the completion notification.

5. The method of claim 1 wherein the request for proposal and the interaction are received via one of a website and an application.

6. The method of claim 1 wherein at least one of the first and second potential sellers has a reputation score based upon prior participation in at least one other project.

7. The method of claim 6 wherein the buyer can review the reputation score associated with at least one of the first and second potential sellers.

8. The method of claim 1 further comprising:
accepting, via the request host, feedback regarding the request for proposal from one of the first and second potential sellers; and
accepting additional funds into the escrow account based upon one or more of the interactions with the first and second potential sellers.

9. The method of claim 1 wherein all funds in the escrow account are provided to the group regardless of whether the project was successfully completed.

10. The method of claim 1 wherein the bid is not accepted if it is lower than the total of funds in the escrow.

11. Apparatus comprising a storage medium storing a program having instructions, which when executed by a processor will cause the processor to process requests for proposals, the instructions of the program for:
receiving a request for proposal including a project to be completed and an estimated budget for the project from a buyer;
accepting funds into an escrow account in order to partially-fund the project;
receiving interaction with the request for proposal from a first potential seller, the interaction including a selected one of (1) discussion regarding the project, and (2) a bid on the project;
receiving interaction with the request for proposal from a second potential seller, the interaction including a selected one of (1) discussion regarding the project, and (2) another bid on the project;
accepting additional funds into the escrow account in order to more fully fund the project;
determining that one of (1) a project award indicating that the project has been awarded or (2) a project term has lapsed; and
providing all funds in the escrow account to a group including at least one of the first potential seller, the second potential seller, and a listing agent.

12. The apparatus of claim 11 wherein the additional funds comprise funding the project to an amount bid by the first potential seller.

13. The apparatus of claim 11 wherein the instructions of the program are further for:
receiving a bid from the first potential seller;
receiving a completion notification indicating that the project has been completed by the first potential seller; and
providing all funds in the escrow account to the group, wherein the group includes at least one of the first potential seller and the listing agent.

14. The apparatus of claim 13 wherein the instructions of the program are further for receiving an indication that the bid has been accepted prior to receiving the completion notification.

15. The apparatus of claim 11 wherein the request for proposal and the interaction are received via one of a website and an application.

16. The apparatus of claim 11 wherein at least one of the first and second potential sellers has a reputation score based upon prior participation in at least one other project.

17. The apparatus of claim 16 wherein the buyer can review the reputation score associated with at least one of the first and second potential sellers.

18. The apparatus of claim 11 wherein the instructions of the program are further for:
accepting feedback regarding the request for proposal from one of the first and second potential sellers; and
accepting additional funds into the escrow account based upon one or more of the interactions with the first and second potential sellers.

19. The apparatus of claim 11 wherein all funds in the escrow account are provided to the group regardless of whether the project was successfully completed.

20. The apparatus of claim 11 wherein the bid is not accepted if it is lower than the total of funds in the escrow.

21. The apparatus of claim 11 further comprising:
a processor;
a memory;
wherein the processor and the memory comprise circuits and software for performing the instructions on the storage medium.
